(19) United States
(12) Patent Application Publication
(10) Pub. No.: US 2024/0243262 A1
(43) Pub. Date: Jul. 18, 2024

(54) Method of Producing Positive Electrode Active Material, Positive Electrode Active Material, and All-Solid-State Battery

(71) Applicant: TOYOTA JIDOSHA KABUSHIKI KAISHA, Toyota-shi (JP)

(72) Inventors: Masaru KUBOTA, Okazaki-shi (JP); So YUBUCHI, Sunto-gun (JP)

(73) Assignee: TOYOTA JIDOSHA KABUSHIKI KAISHA, Toyota-shi (JP)

(21) Appl. No.: 18/404,465

(22) Filed: Jan. 4, 2024

(30) Foreign Application Priority Data
Jan. 18, 2023 (JP) 2023-005712

(51) Int. Cl. H01M 4/36; H01M 4/02; H01M 4/505; H01M 4/62; H01M 10/0562

(52) U.S. Cl. CPC H01M 4/366; H01M 4/505; H01M 4/628; H01M 10/0562; H01M 2004/021; H01M 2004/028; H01M 2300/0068

(57) ABSTRACT

A method of producing a positive electrode active material comprises the following (a) and (b): (a) preparing a slurry by dispersing an active material particle in a coating liquid; and (b) performing spray drying to dry the slurry to produce a positive electrode active material. The active material particle includes an O2-type layered oxide. The coating liquid includes a solute and a solvent. The solute includes at least one selected from the group consisting of Nb, P, and B. The slurry has a solid concentration of more than 42% and not more than 51%.

### CROSS REFERENCE TO RELATED APPLICATIONS

This nonprovisional application is based on Japanese Patent Application No. 2023-005712 filed on Jan. 18, 2023, with the Japan Patent Office, the entire contents of which are hereby incorporated by reference.

### BACKGROUND OF THE DISCLOSURE

### Field

The present disclosure relates to a method of producing a positive electrode active material, a positive electrode active material, and an all-solid-state battery.

### Description of the Background Art

Japanese Patent Laying-Open No. 2022-097885 discloses a positive electrode active material that has an O2-type structure.

### SUMMARY OF THE DISCLOSURE

An all-solid-state battery comprises a positive electrode active material and a sulfide solid electrolyte. The sulfide solid electrolyte may form an ion conduction path inside the electrode. When the sulfide solid electrolyte comes into direct contact with the positive electrode active material, degradation of the sulfide solid electrolyte may be facilitated. It may be because the positive electrode active material has a high electric potential. With the degradation of the sulfide solid electrolyte being facilitated, post-endurance (after storage at a high temperature, for example) resistance increment may increase.

Providing a coating film to a positive electrode active material (active material particles) has been suggested. With a coating film interposed between a sulfide solid electrolyte and a positive electrode active material, degradation of the sulfide solid electrolyte may be reduced. The coating film may be formed by spray drying, for example.

Conventionally, as a positive electrode active material, a layered oxide having an O3-type structure (also called “an O3-type layered oxide” hereinafter) is widely used. Recently, a layered oxide having an O2-type structure (also called “an O2-type layered oxide” hereinafter) has also been suggested. An O2-type layered oxide is expected to have high capacity.

It was found that when applying an O2-type layered oxide to an all-solid-state battery, the thickness of the coating film needs to be 4 nm or more for sufficiently reducing degradation of the sulfide solid electrolyte. Generally, the thicker the coating film is, the higher the covering rate tends to be. However, on the surface of the O2-type layered oxide, even when the coating film is made thick, the covering rate tends not to be increased. With an insufficient covering rate, resistance increment may increase.

An object of the present disclosure is to reduce resistance increment.

Hereinafter, the technical configuration and effects of the present disclosure will be described. It should be noted that the action mechanism according to the present specification includes presumption. The action mechanism does not limit the technical scope of the present disclosure.
1. A method of producing a positive electrode active material comprises the following (a) and (b):
(a) preparing a slurry by dispersing an active material particle in a coating liquid; and
(b) performing spray drying to dry the slurry to produce a positive electrode active material.

The active material particle includes an O2-type layered oxide. The coating liquid includes a solute and a solvent. The solute includes at least one selected from the group consisting of Nb, P, and B. The slurry has a solid concentration of more than 42% and not more than 51%.

In spray drying, the slurry is sprayed to form droplets of the slurry. The droplet includes the coating liquid and the active material particle. The coating liquid is a precursor of a coating film. The droplets are dried, and thereby a coating film may deposit on the surface of the active material particle. Usually, in spray drying, the solid concentration of the slurry is adjusted to be high. It is because the higher the solid concentration, the more advantageous for drying. Conventionally, the solid concentration of the slurry may be 60% or more, for example.

In the method of producing a positive electrode active material according to “1” above, the solid concentration of the slurry is further decreased. More specifically, the solid concentration is 51% or less. Although the mechanism is not known in details, it seems that when the solid concentration of the slurry is 51% or less, on the surface of the O2-type layered oxide (the active material particle), a thick and high-covering-rate coating film tends to deposit. However, when the solid concentration is 42% or less, both the thickness and the covering rate of the coating film tend to be decreased.
2. In the method of producing a positive electrode active material according to “1” above, the coating liquid may further include a surfactant. The surfactant may include, for example, at least one selected from the group consisting of polyether-modified silicone and polyethylene glycol alkyl ether.

With the coating liquid including a surfactant, the covering rate is expected to be enhanced.
3. The positive electrode active material includes an active material particle and a coating film. The active material particle includes an O2-type layered oxide. The coating film covers at least part of a surface of the active material particle. The coating film includes at least one selected from the group consisting of Nb, P, and B. The coating film has a thickness of 4 nm or more. The covering rate of the surface of the active material particle with the coating film is 80% or more. The covering rate is measured by X-ray photoelectron spectrometry.

For instance, by the method of producing a positive electrode active material according to “1” or “2” above, on the surface of the O2-type layered oxide, a coating film with a thickness of 4 nm or more and a covering rate of 80% or more may be achieved.
4. The positive electrode active material according to “3” above may have a D10 of 3 μm or less in volume-based particle size distribution, for example.

At the time of spray drying, granulation of the active material particles (aggregation of the particles) may occur. Granulation may inhibit the covering rate from increasing. When D10 after spray drying is 3 μm or less, there is a chance that the granulation was mild.
5. The positive electrode active material according to “3” or “4” above may have a D90 of 15 μm or less in volume-based particle size distribution.

When D90 after spray drying is 15 μm or less, there is a chance that the granulation was mild.
6. An all-solid-state battery comprises the positive electrode active material according to any one of “3” to “5” above and a sulfide solid electrolyte.

Next, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that certain configurations of the present embodiment and the present example can be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart illustrating a method of producing a positive electrode active material according to the present embodiment.

FIG. 2 is a conceptual view illustrating a positive electrode active material according to the present embodiment.

FIG. 3 is a conceptual view illustrating an all-solid-state battery according to the present embodiment.

FIG. 4 is a table showing details of experiment.

FIG. 5 is a graph of the relationship between covering rate and resistance increment.

FIG. 6 is a graph of the relationship between D10 and resistance increment.

FIG. 7 is a graph of the relationship between D90 and resistance increment.

### DESCRIPTION OF THE PREFERRED EMBODIMENTS

### 1. Terms and Definitions, Etc.

A description of some of the terms used in the specification will be provided. Terms that are not described here may be defined and/or described in the specification every time the term is used.

Expressions such as “comprise”, “include”, and “have”, and other similar expressions (such as “be composed of”, for example) are open-ended expressions. In an open-ended expression, in addition to an essential component, an additional component may or may not be further included. The expression “consist of” is a closed-end expression. However, even when a closed-end expression is used, impurities present under ordinary circumstances as well as an additional element irrelevant to the technique according to the present disclosure are not excluded. The expression “consist essentially of” is a semiclosed-end expression. A semiclosed-end expression tolerates addition of an element that does not substantially affect the fundamental, novel features of the technique according to the present disclosure.

Expressions such as “may” and “can” are not intended to mean “must” (obligation) but rather mean “there is a possibility” (tolerance).

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

“At least one of A and B” includes “A or B” and “A and B”. “At least one of A and B” may also be expressed as “A and/or B”.

A singular form also includes its plural meaning, unless otherwise specified. For example, “a particle” may mean not only “one particle” but also “a plurality of particles (a particle group)” and “a group of particles (powder)”.

Any geometric term (such as “parallel”, “vertical”, and “orthogonal”, for example) should not be interpreted solely in its exact meaning. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. The dimensional relationship (in length, width, thickness, and the like) in each figure may have been changed for the purpose of assisting understanding for the readers. Further, a part of a given configuration may have been omitted.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. “Not less than” and “not more than” are represented by an inequality sign with an equality sign “≤”. “More than” and “less than” are represented by an inequality sign “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. The molar ratio between Al and O is not limited, unless otherwise specified. Further, the compound may be doped with a trace element. Some of Al and/or O may be replaced by another element, for example.

“Derivative” refers to a compound that is derived from its original compound by at least one partial modification selected from the group consisting of substituent introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring.

A derivative of a polymer compound (a resin material) may also be called “a modified product”.

“Copolymer” includes at least one selected from the group consisting of unspecified-type, statistical-type, random-type, alternating-type, periodic-type, block-type, and graft-type.

“Solid concentration” of the slurry to be subjected to spray drying refers to the total mass fraction of the components other than solvent.

“D10” refers to a particle size in volume-based particle size distribution (cumulative distribution) at which the cumulative frequency reaches 10%. Similarly, “D50” refers to a particle size at which the cumulative frequency reaches 50%. “D90” refers to a particle size at which the cumulative frequency reaches 90%. The particle size distribution may be measured by laser diffraction. For instance, “AEROTRAC II” (trade name) manufactured by MicrotracBEL (or a similar product) and/or the like may be used to measure the particle size distribution.

“O2-type layered oxide” refers to a layered oxide having an O2-type structure. “O2-type structure” is one type of layered crystal structure. In an O2-type structure, two types of oxide layer (MeO₂ layer) with different positions of oxygen are present in a unit cell. The MeO₂ layer includes a metal (Me) and oxygen (O). In an O2-type structure, Li occupies an octahedral site. “O” in O2-type comes from “Octahedral”. The presence or absence of an O2-type structure in the substance being analyzed may be determined with the use of XRD (X-Ray Diffraction) spectra. In the XRD spectra for the substance being analyzed, when a peak attributable to an O2-type structure exhibits the highest diffraction intensity, it is considered that the substance being analyzed has an O2-type structure. In the XRD measurement, a CuKα ray may be used.

“Covering rate” is measured by XPS (X-ray Photoelectron Spectroscopy). For example, an XPS apparatus with the trade name “PHI X-tool” manufactured by ULVAC-PHI (or a similar product) and/or the like may be used. A positive electrode active material (powder) is loaded in the XPS apparatus. With a pass energy of 224 eV, narrow scan analysis is carried out. The measurement data is processed with an analysis software. For example, an analysis software with the trade name “MulTiPak” manufactured by ULVAC-PHI (or a similar product) and/or the like may be used. The XPS spectra are analyzed, and from the peak areas for Li1s, C1s, O1s, B1s, P2p, Me2p3, and the like, the ratios of the elements (the element concentrations) are determined. By the following equation (1-1), the covering rate is determined.

$$θ = X / ( X + Me ) \times 100 \qquad ( 1 - 1 )$$

In the above equation (1-1), 0 represents the covering rate (%).

X represents the ratio of element included in a coating film (except Li and O). X includes at least one selected from the group consisting of Nb, P, and B.

Me represents the ratio of element included in active material particles (except Li and O). Me may include, for example, at least one selected from the group consisting of Ni, Co, Mn, and Al.

For example, when the coating film includes B and P and the active material particles include Ni, Co, and Mn, the right side of the above equation (1-1) may be changed to “(P+B)/(P+B+Ni+Co+Mn)”.

“Thickness of the coating film” is determined by the following equation (1-2).

$$t = W / A \qquad ( 1 - 2 )$$

$$t : Thickness of coating film$$

$$W : Deposited volume of coating film$$

A: BET specific surface area of positive electrode active material

The dimension of the BET specific surface area is [length]²×[mass]⁻¹. The BET specific surface area is measured by a gas adsorption method (a BET one point method). The deposited volume of the coating film is a value per unit mass of the positive electrode active material. The dimension of the deposited volume of the coating film is [length]³×[mass]⁻¹. For example, by ICP-AES (Inductively Coupled Plasma Atomic Emission Spectroscopy), the mass concentration of a substance attributable to the coating film is measured. From the density of the substance, the volume of the substance per unit mass of the positive electrode active material (namely, the deposited volume) is determined.

### 2. Method of Producing Positive Electrode Active Material

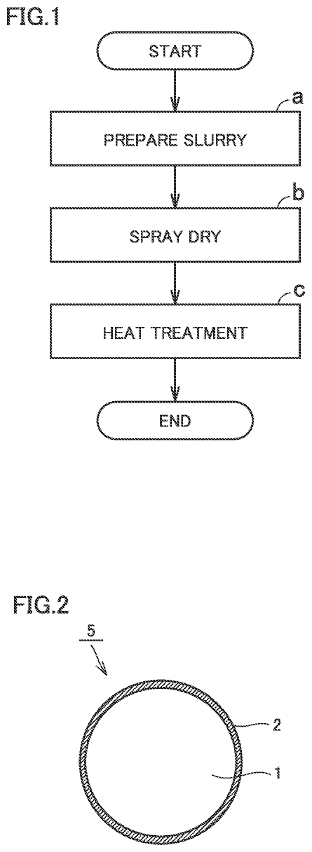

FIG. 1 is a schematic flowchart illustrating a method of producing a positive electrode active material according to the present embodiment. Hereinafter, “the method of producing a positive electrode active material according to the present embodiment” may be simply called “the present production method”. The present production method includes “(a) preparing a slurry” and “(b) spray drying”. The present production method may further include “(c) heat treatment” and the like, for example.

### 2-1. (a) Preparing Slurry

The present production method includes preparing a slurry by dispersing active material particles in a coating liquid. The slurry may be prepared with any dispersing apparatus. Here, the solid concentration of the slurry is more than 42% and not more than 51%. With the solid concentration of the slurry being more than 42% and not more than 51%, a desirable coating film may be formed. The solid concentration of the slurry may be 43% or more, or 45% or more, or 47% or more, or 49% or more, for example. The solid concentration of the slurry may be 49% or less, or 47% or less, or 45% or less, or 43% or less, for example.

### 2-1-1. Active Material Particles

The active material particles may have a D50 from 3 to 10 μm, for example. The active material particles include an O2-type layered oxide. The O2-type layered oxide may be produced by ion exchange, for example. More specifically, a P2-type layered oxide including Na ions is prepared. The Na ions of the P2-type layered oxide are replaced with Li ions. With the replacement of Na ions with Li ions, the P2-type structure may shift to a more stable O2-type structure. The O2-type layered oxide includes Li, metal (Me), and oxygen (O). The O2-type layered oxide may have a composition represented by the following formula (1-3), for example.

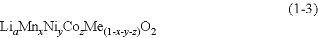

In the above formula (1-3), the relationships of 0≤x≤1, 0≤y≤1, 0≤z≤1, 0<x+y+z≤1 may be satisfied, for example. The relationship of 0.5≤a≤1 may be satisfied, for example. Me may be at least one selected from the group consisting of Al, Fe, Mg, Ca, Ti, Cr, Cu, Zn, Nb, and Mo, for example.

In the above formula (1-3), the relationships of y<x, z<x, y<z, 0.5≤x≤1 may be satisfied, for example.

The O2-type layered oxide may consist of an O2-type structure. That is, the O2-type layered oxide may be a single-phase material. A part of the O2-type layered oxide may include an O3-type structure. In an “O3-type structure”, three types of MeO₂ layer with different positions of oxygen are present in a unit cell. Li occupies an octahedral site. For example, the relationship of the following expression (1-4) may be satisfied.

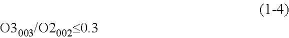

O3₀₀₃: Intensity of peak in XRD spectra attributable to 003 plane of O3-type structure
O2₀₀₂: Intensity of peak in XRD spectra attributable to 002 plane of O2-type structure

In the above expression (1-4), “O3₀₀₃/O2₀₀₂” may be 0.2 or less, or 0.1 or less, for example.

A part of the O2-type layered oxide may include a P2-type structure. In a “P2-type structure”, two types of MeO₂ layer with different positions of oxygen are present in a unit cell. Li occupies a triangular prismatic site. “P” in a P2-type structure comes from “Prismatic”. For example, the relationship of the following expression (1-5) may be satisfied.

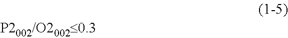

P2₀₀₂: Intensity of peak in XRD spectra attributable to 002 plane of P2-type structure
O2₀₀₂: Intensity of peak in XRD spectra attributable to 002 plane of O2-type structure

In the above expression (1-5), “P2₀₀₂/O2₀₀₂” may be 0.2 or less, or 0.1 or less, for example.

The O2-type layered oxide is expected to have a high capacity as compared to the O3-type layered oxide. On the other hand, the O2-type layered oxide tends to have a high resistance as compared to the O3-type layered oxide. For example, the present production method may include making the active material particles into fine particles. For example, the active material particles (O2-type layered oxide) may be pulverized. For example, a precursor of the active material particles (such as P2-type layered oxide) may be pulverized. With the active material particles made into fine particles, the specific surface area may increase. With the increase of the specific surface area, resistance is expected to be reduced. However, with the active material particles made into fine particles, at the time of spray drying, granulation may be facilitated. In the present embodiment, a particular coating liquid is used and thereby granulation may be reduced.

The active material particles may be solid particles, or may be hollow particles. Each of a hollow particle and a solid particle is a secondary particle (an aggregate of primary particles). In a cross-sectional image of “a hollow particle”, the proportion of the area of the central cavity relative to the entire cross-sectional area of the particle is 30% or more. The proportion of the cavity in a hollow particle may be 40% or more, or 50% or more, or 60% or more, for example. In a cross-sectional image of “a solid particle”, the proportion of the area of the central cavity relative to the entire cross-sectional area of the particle is less than 30%. The proportion of the cavity in a solid particle may be 20% or less, or 10% or less, or 5% or less, for example. As the active material particles, a mixture of hollow particles and solid particles may be used. The mixing ratio (mass ratio) between hollow particles and solid particles may be “(hollow particles)/(solid particles)=1/9 to 9/1”, or “(hollow particles)/(solid particles)=2/8 to 8/2”, or “(hollow particles)/(solid particles)=3/7 to 7/3”, or “(hollow particles)/(solid particles)=4/6 to 6/4”, for example.

### 2-1-2. Coating Liquid

The coating liquid includes a solute and a solvent. The coating liquid may further include suspended matter (an insoluble component), sediment, and the like, for example.

As long as it can dissolve the solute, the solvent may include any component. The solvent may include water, alcohol, and/or the like, for example. The solvent may include ion-exchanged water, ethanol, hydrogen peroxide solution, and/or the like, for example.

The amount of the solute may be, for example, from 0.1 to 20 parts by mass, or from 1 to 15 parts by mass, or from 5 to 10 parts by mass, relative to 100 parts by mass of the solvent. The solute includes a material of the coating film. The solute includes at least one selected from the group consisting of Nb, P, and B. The solute may further include Li, for example.

The solute may include phosphoric acid, phosphoric acid salt, boric acid, boric acid salt, niobic acid, niobic acid salt, lithium compound, and/or the like, for example. The solute may include, for example, at least one selected from the group consisting of anhydrous phosphoric acid (P₂O₅), orthophosphoric acid, pyrophosphoric acid, metaphosphoric acid [(HPO₃)ₙ], polyphosphoric acid, orthoboric acid (H₃BO₃), metaboric acid (HBO₂), niobic acid (Nb₂O₅·3H₂O), and lithium hydroxide.

The coating liquid may further include a surfactant. With the coating liquid including a surfactant, the covering rate is expected to be enhanced. The surfactant may be an insoluble component. The surfactant may be a soluble component (solute). The surfactant may be soluble in water, for example. With a surfactant thus dissolved, the covering rate may be enhanced. The surfactant may be cationic, anionic, amphoteric, or nonionic. With the surfactant being nonionic, the covering rate may be enhanced. The surfactant may include, for example, at least one selected from the group consisting of polyether-modified silicone and polyethylene glycol alkyl ether.

As the polyether-modified silicone, “Silsurf C208” (trade name, manufactured by SILTECH), “KF-945” (trade name, manufactured by Shin-Etsu Chemical), and the like may be used, for example. As the polyethylene glycol alkyl ether, polyethylene glycol monolauryl ether and the like may be used, for example.

The coating liquid may include the surfactant in a mass fraction from 0.1 to 1.5%, for example. The mass fraction of the surfactant (the amount to be added) may be from 0.1 to 0.5%, or from 0.5 to 1%, for example. The amount of the surfactant to be added may be from 0.2 to 0.8%, or from 0.3 to 0.7%, or from 0.4 to 0.6%, for example.

### 2-2. (b) Spray Drying

The present production method includes performing spray drying to dry the slurry to produce a positive electrode active material. In the present production method, any spray drying apparatus may be used. For example, the slurry may be sprayed from a nozzle to form droplets. The droplets are dried by hot air. The slurry may be dried on the surface of the active material particles, and thereby a coating film may deposit. With the formation of the coating film, a positive electrode active material (composite particles) may be produced. The diameter of the nozzle may be from 0.1 to 10 mm, or from 0.1 to 1 mm, for example. The temperature of the hot air may be from 100 to 200° C., for example.

### 2-3. (c) Heat Treatment

The present production method may include heat treatment of the positive electrode active material. The heat treatment allows the coating film to be fixed. The heat treatment may also be called “calcination”. In the present production method, any heat treatment apparatus may be used. The treatment temperature may be from 150 to 300° C., for example. The treatment duration may be from 1 to 10 hours, for example. The heat treatment may be carried out in an air atmosphere, or in an inert atmosphere, for example.

### 3. Positive Electrode Active Material

The positive electrode active material is powder. The particle size distribution of the positive electrode active material may have D10, D50, and D90 as specified below, for example.
D10: from 1 to 4 μm
D50: from 3 to 10 μm
D90: from 5 to 20 μm

When D50 is 10 μm or less, initial resistance is expected to be reduced, for example. D50 may be 8 μm or less, or 4.9 μm or less, for example. D50 may be 3.2 μm or more, or 4.1 μm or more, for example.

When D10 is 3 μm or less, there is a chance that granulation was mild at the time of spray drying. D10 may be 2.9 μm or less, or 2.2 μm or less, for example. D10 may be 1.8 μm or more, for example.

When D90 is 15 μm or less, there is a chance that granulation was mild at the time of spray drying. D90 may be 11.9 μm or less, or 10.4 μm or less, or 9.3 μm or less, or 8.6 μm or less, for example. D90 may be 5.8 μm or more, for example.

The span of the particle size distribution (a dimensionless amount) may be from 1.5 to 2.5, or from 1.6 to 2.0, or from 1.6 to 1.9, for example. The span (Sp) is determined by the following equation (1-6).

$$Sp = ( D 90 - D 10 ) / D 50 \qquad ( 1 - 6 )$$

The ratio of D90 to D10 (D90/D10) may be 5 or less, or 4.5 or less, or 4.3 or less, or 4.2 or less, or 4.1 or less, or 4.0 or less, for example. This ratio (D90/D10) may be 3 or more, or 3.5 or more, or 3.8 or more, or 3.9 or more, for example.

The ratio of D90 to D50 (D90/D50) may be 2.2 or less, or 2.1 or less, or 2.0 or less, for example. This ratio (D90/D50) may be 1.8 or more, or 1.9 or more, for example.

The ratio of D50 to D10 (D50/D10) may be 2.5 or less, or 2.3 or less, for example. This ratio (D50/D10) may be 2.0 or more, or 2.1 or more, for example.

FIG. 2 is a conceptual view illustrating a positive electrode active material according to the present embodiment. A positive electrode active material 5 may also be called “a covered active material” and the like, for example. Positive electrode active material 5 includes composite particles. The composite particle has a core-shell structure. More specifically, positive electrode active material 5 includes an active material particle 1 and a coating film 2. Active material particle 1 is the core of positive electrode active material 5. Active material particle 1 includes an O2-type layered oxide. The details of active material particle 1 are as described above.

Coating film 2 is a shell for positive electrode active material 5. Coating film 2 has a thickness of 4 nm or more. The thickness of coating film 2 may be 4.2 nm or more, or 4.4 nm or more, or 5.2 nm or more, for example. The thickness of coating film 2 may be 50 nm or less, or 30 nm or less, or 20 nm or less, or 15 nm or less, or 10 nm or less, or 8 nm or less, or 5.6 nm or less, or 5.3 nm or less, for example.

The covering rate by coating film 2 is 80% or more. The higher the covering rate is, the more reduced the resistance increment is expected to be. The covering rate may be 83% or more, or 86% or more, or 89% or more, or 91% or more, or 92% or more, or 94% or more, for example. The covering rate may be 100% or less, or 99% or less, or 98% or less, or 97% or less, or 96% or less, or 95% or less, for example.

Coating film 2 includes at least one selected from the group consisting of Nb, P, and B. Coating film 2 may further include Li and O. Coating film 2 may include oxide glass and/or the like, for example. Oxide glass may have a network structure. Coating film 2 may include, for example, at least one selected from the group consisting of a phosphoric acid framework and a boric acid framework. For example, when fragments of PO₂⁻, PO₃⁻, and/or the like are detected in TOF-SIMS (Time-of-Flight Secondary Ion Mass Spectrometry) spectra of positive electrode active material 5, it is regarded that coating film 2 includes a phosphoric acid framework. When fragments of BO₂⁻, BO₃⁻, and/or the like are detected in TOF-SIMS spectra, it is regarded that coating film 2 includes a boric acid framework.

Coating film 2 may include B, P, and O, for example. When coating film 2 includes B and P, the relationship of “B/P=9/1 to 1/9”, or “B/P=8/2 to 2/8”, or “B/P=7/3 to 3/7”, or “B/P=6/4 to 4/6” in molar ratio may be satisfied, for example.

Positive electrode active material 5 may satisfy the relationship of the following expression (1-7), for example.

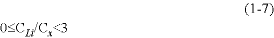

C_{Li}: Element concentration of Li measured by XPS
Cₓ: Element concentration of elements included in coating film 2 measured by XPS (except Li and O).

XPS allows for acquiring information about the composition of the outermost surface of positive electrode active material 5. It is conceivable that the element concentration measured by XPS indicates the element concentration in coating film 2. The smaller the element concentration ratio “C_{Li}/Cₓ” in coating film 2 is, the more reduced the initial resistance is expected to be, for example. “C_{Li}/Cₓ” may be 2.5 or less, or 2.0 or less, or 1.5 or less, or 1.0 or less, for example. “C_{Li}/Cₓ” may be 0.1 or more, or 0.3 or more, or 0.5 or more, for example. When coating film 2 includes P and B, for example, Cₓ is determined by the mathematical expression “Cₓ=C_{P}+C_{B}”. C_{P} represents the element concentration of P, and C_{B} represents the element concentration of B.

### 4. All-Solid-State Battery

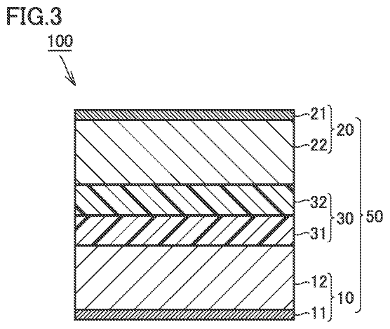

FIG. 3 is a conceptual view illustrating an all-solid-state battery according to the present embodiment. A battery 100 may be used in any application. For example, battery 100 may be used for an electric power supply of an electric vehicle, an electric tool, and the like. Battery 100 may have any outer shape. Battery 100 may have a plate-like outer shape, for example. Battery 100 includes a power generation element 50.

### 4-1. Exterior Package

Battery 100 may include an exterior package (not illustrated). The exterior package may accommodate power generation element 50. The exterior package may have any configuration. The exterior package may be a case made of metal, or may be a pouch made of a metal foil laminated film, for example. The exterior package may include Al and/or the like, for example. The exterior package may accommodate a single power generation element 50, or may accommodate a plurality of power generation elements 50, for example. The plurality of power generation elements 50 may form a series circuit, or may form a parallel circuit, for example. Inside the exterior package, the plurality of power generation elements 50 may be stacked in the thickness direction of battery 100.

Inside the exterior package, a cushioning material may be interposed between the exterior package and power generation element 50. The cushioning material is elastically deformable. The cushioning material may include a spring, a cushion, and/or the like, for example. In the case when battery 100 is mounted on an electric tool, for example, vibration is applied to power generation element 50. Due to the vibration, power generation element 50 may be damaged. The cushioning material may reduce the vibration that is applied to power generation element 50.

### 4-2. Power Generation Element

Power generation element 50 may also be called “an electrode group”, “an electrode assembly”, and the like. Power generation element 50 includes a positive electrode 10 and a negative electrode 20. Power generation element 50 may further include a separator layer 30. Separator layer 30 is interposed between positive electrode 10 and negative electrode 20. Power generation element 50 may have any configuration. Power generation element 50 may have a monopolar structure, or may have a bipolar structure, for example. In a bipolar structure, a positive electrode active material layer and a negative electrode active material layer may be placed on the respective sides of a current collector.

### 4-3. Positive Electrode

Positive electrode 10 is in sheet form. Positive electrode 10 may include a positive electrode current collector 11 and a positive electrode active material layer 12, for example.

### 4-3-1. Positive Electrode Current Collector

Positive electrode current collector 11 is electrically conductive. Positive electrode current collector 11 supports positive electrode active material layer 12. Positive electrode current collector 11 may be in sheet form, for example. Positive electrode current collector 11 may have a thickness from 5 to 50 μm, for example.

Positive electrode current collector 11 may have a monolayer structure, or may have a multilayer structure. Positive electrode current collector 11 may include, for example, at least one selected from the group consisting of a metal layer and an electrically-conductive resin layer. The metal layer may include at least one selected from the group consisting of a metal foil and a metallized film, for example. The metal layer may include at least one selected from the group consisting of Al, Mn, Ti, Fe, and Cr, for example. The metal layer may include an Al foil, an Al alloy foil, a Ti foil, a stainless steel (SUS) foil, and/or the like, for example. The electrically-conductive resin layer may include a matrix resin and an electrically-conductive filler, for example. The matrix resin may include polyolefin and/or the like, for example. The electrically-conductive filler may include at least one selected from the group consisting of carbon particles, carbon fibers, metal particles, and metal fibers, for example.

Positive electrode current collector 11 may further include PTC (Positive Temperature Coefficient) layer, for example. The PTC layer increases the resistance at the time when battery 100 is under a high temperature. The PTC layer may include a thermally expandable microcapsule, a conductive material, a binder, and the like, for example. As the thermally expandable microcapsule, “Matsumoto Microsphere” (trade name, registered trademark) manufactured by Matsumoto Yushi-Seiyaku, “Expancel” (trade name, registered trademark) manufactured by Japan Fillite, and/or the like may be used, for example. The thermally expandable microcapsule may be covered with a metal material (such as an Al deposited film, for example). At the time when battery 100 is under a high temperature, the thermally expandable microcapsule may expand and thereby the resistance of the PTC layer may be increased.

Positive electrode current collector 11 may include a buffer layer, for example. The buffer layer may include a cushioning material. The cushioning material may include resin foam and/or the like, for example. At the time when positive electrode 10 is roll-pressed, for example, the load applied to the metal layer (such as a metal foil), positive electrode active material layer 12, and the like is expected to be reduced by the buffer layer.

### 4-3-2. Positive Electrode Active Material Layer

Positive electrode active material layer 12 is placed on the surface of positive electrode current collector 11. Positive electrode active material layer 12 may be placed on only one side of positive electrode current collector 11. Positive electrode active material layer 12 may be placed on both sides of positive electrode current collector 11. Positive electrode active material layer 12 may have a thickness from 10 to 1000 μm, or from 50 to 500 μm, or from 100 to 300 μm, for example. Positive electrode active material layer 12 includes a positive electrode active material and a sulfide solid electrolyte. Positive electrode active material layer 12 may further include a conductive material, a binder, and the like, for example.

Positive electrode active material layer 12 includes the positive electrode active material according to the present embodiment described above. Positive electrode active material layer 12 may include one type of positive electrode active material. Positive electrode active material layer 12 may include multiple types of positive electrode active material. For example, positive electrode active material layer 12 may include two or more types of positive electrode active material that are different from one another in particle size distribution. For example, in the case when large particles and small particles are mixed together, the filling factor of positive electrode active material layer 12 may be enhanced. The large particles have a great D50 as compared to the small particles. The mixing ratio (mass ratio) between the large particles and the small particles may be “(large particles)/(small particles)=1/9 to 9/1”, or “(large particles)/(small particles)=5/5 to 9/1”, or “(large particles)/(small particles)=7/3 to 9/1”, for example.

Positive electrode active material layer 12 may include two or more types of positive electrode active material that are different from one another in composition. Hereinafter, for the sake of convenience, the positive electrode active material according to the present embodiment (a covered active material including an O2-type layered oxide) is referred to as a first positive electrode active material. In addition to the first positive electrode active material, positive electrode active material layer 12 may further include a second positive electrode active material. The second positive electrode active material may also be a covered active material. The second positive electrode active material may include an O3-type layered oxide, a polyanion compound, and/or the like, for example. The mixing ratio (mass ratio) between the first positive electrode active material and the second positive electrode active material may be “(first positive electrode active material)/(second positive electrode active material)=9/1 to 1/9”, or “(first positive electrode active material)/(second positive electrode active material)=8/2 to 2/8”, or “(first positive electrode active material)/(second positive electrode active material)=7/3 to 3/7”, for example.

The O3-type layered oxide may be represented by the following formulae (1-8) to (1-10), for example.

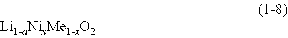

In the above formula (1-8), the relationships of −0.5≤a≤0.5, 0≤x≤1 are satisfied. Me may include, for example, at least one selected from the group consisting of Co, Mn, and Al.

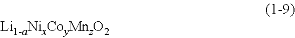

In the above formula (1-9), the relationships of −0.5≤a≤0.5, 0<x<1, 0<y<1, 0<z<1, x+y+z=1 are satisfied.

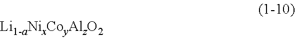

In the above formula (1-10), the relationships of −0.5≤a≤0.5, 0<x<1, 0<y<1, 0<z<1, x+y+z=1 are satisfied.

The polyanion compound may be represented by the following formula (1-11), for example.

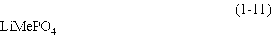

In the above formula (1-11), Me may include, for example, at least one selected from the group consisting of Fe, Mn, and Co.

### 4-3-3. Sulfide Solid Electrolyte

The sulfide solid electrolyte may form an ion conduction path inside positive electrode active material layer 12. The sulfide solid electrolyte may be powder, for example. The sulfide solid electrolyte may have a D50 from 0.1 to 3 μm, for example. The D50 of the sulfide solid electrolyte may be 1 μm or less, or 0.5 μm or less, or 0.1 μm or less, for example. The D50 of the sulfide solid electrolyte may be 0.05 μm or more, or 0.1 μm or more, for example. The amount of the sulfide solid electrolyte to be used may be, for example, from 1 to 200 parts by volume, or from 50 to 150 parts by volume, or from 50 to 100 parts by volume, relative to 100 parts by volume of the positive electrode active material.

The sulfide solid electrolyte may be glass ceramic, or may be argyrodite, for example. The sulfide solid electrolyte may include, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₂P₃S₁₁, Li₃PS₄, Li₂PS₆, and Li₆PS₅X (X=Cl, Br, I).

For example, “LiI—LiBr—Li₃PS₄” refers to a sulfide solid electrolyte produced by mixing LiI, LiBr, and Li₃PS₄ in a freely-selected molar ratio. For example, the sulfide solid electrolyte may be produced by a mechanochemical method. “Li₂S—P₂S₅” includes Li₃PS₄. Li₃PS₄ may be produced by mixing Li₂S and P₂S₅ in “Li₂S/P₂S₅=75/25 (molar ratio)”, for example.

The sulfide solid electrolyte may have a raw material composition represented by the following formula (2-1), for example.

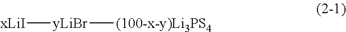

The above formula (2-1) indicates that the raw material composition is “LiI/LiBr/Li₃PS₄=x/y/(100−x−y)” in molar ratio. For example, the relationships of 0≤x≤30, 0≤y≤30, 0≤x+y≤30 may be satisfied.

The sulfide solid electrolyte may have a composition represented by the following formula (2-2), for example.

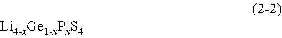

In the above formula (2-2), the relationship of 0.55≤x≤0.76 may be satisfied, for example.

In addition to the sulfide solid electrolyte, positive electrode active material layer 12 may further include other solid electrolytes. Hereinafter, for the sake of convenience, the sulfide solid electrolyte is also called “a first solid electrolyte” and another solid electrolyte is also called “a second solid electrolyte”. The volume ratio of the first solid electrolyte and the second solid electrolyte may be “(first solid electrolyte)/(second solid electrolyte)=1/99 to 99/1”, or “(first solid electrolyte)/(second solid electrolyte)=1/9 to 9/1”, or “(first solid electrolyte)/(second solid electrolyte)=3/7 to 7/3”, for example. The first solid electrolyte and the second solid electrolyte may have been subjected to composing treatment.

The second solid electrolyte may include, for example, at least one selected from the group consisting of a halide solid electrolyte, an oxide solid electrolyte, a hydride solid electrolyte, and a nitride solid electrolyte.

The halide solid electrolyte may be represented by the following formula (2-3), for example.

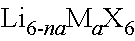

In the above formula (2-3), n represents an oxidation number of M. For example, M may include an atom whose oxidation number is ±3. For example, M may include an atom whose oxidation number is ±4. M may include, for example, at least one selected from the group consisting of Y, Al, Ti, Zr, Ca, and Mg. a may satisfy the relationship of 0<a<2. X may include, for example, at least one selected from the group consisting of F, Cl, Br, and I.

The halide solid electrolyte may be represented by the following formula (2-4), for example.

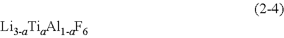

In the above formula (2-4), a may satisfy the relationship of 0≤a≤0.1, or 0.1≤a≤0.2, or 0.2≤a≤0.3, or 0.3≤a≤0.4, or 0.4≤a≤0.5, or 0.5≤a≤0.6, or 0.6≤a≤0.7, or 0.7≤a≤0.8, or 0.8≤a≤0.9, or 0.9≤a≤1, for example.

The halide solid electrolyte may be represented by the following formula (2-5), for example.

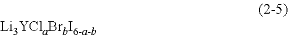

In the above formula (2-5), the relationship of 0≤a+b≤6 is satisfied. a may satisfy the relationship of 0≤a≤1, or 1≤a≤2, or 2≤a≤3, or 3≤a≤4, or 4≤a≤5, or 5≤a≤6, for example. b may satisfy the relationship of 0≤b≤1, or 1≤b≤2, or 2≤b≤3, or 3≤b≤4, or 4≤b≤5, or 5≤b≤6, for example.

The oxide solid electrolyte may include, for example, at least one selected from the group consisting of LiNbO₃, Li_{1.5}Al_{0.5}Ge_{1.5}(PO₄)₃, La_{2/3-x}Li₃ₓTiO₃, and Li₇La₃Zr₂O₁₂. The hydride solid electrolyte may include LiBH₄ and/or the like, for example. The nitride solid electrolyte may include Li₃N, Li₃BN₂, and/or the like, for example.

### 4-3-4. Conductive Material

The conductive material may form an electron conduction path inside positive electrode active material layer 12. The amount of the conductive material to be used may be, for example, from 0.1 to 10 parts by mass relative to 100 parts by mass of the positive electrode active material. The conductive material may include any component. The conductive material may include, for example, at least one selected from the group consisting of graphite, acetylene black (AB), Ketjenblack (registered trademark), vapor grown carbon fibers (VGCFs), carbon nanotubes (CNTs), and graphene flakes (GFs). The CNTs may include at least one selected from the group consisting of single-walled CNTs (SWCNTs) and multi-walled CNTs (MWCNTs).

### 4-3-5. Binder

The binder is capable of fixing positive electrode active material layer 12 to positive electrode current collector 11. The amount of the binder to be used may be, for example, from 0.1 to 10 parts by mass relative to 100 parts by mass of the positive electrode active material. The binder may include any component. The binder may include, for example, at least one selected from the group consisting of polyvinylidene difluoride (PVdF), vinylidene difluoride-hexafluoropropylene copolymer (PVdF-HFP), polytetrafluoroethylene (PTFE), carboxymethylcellulose (CMC), polyacrylic acid (PAA), polyvinyl alcohol (PVA), polyvinylpyrrolidone (PVP), polyoxyethylene alkyl ether, and derivatives of these.

### 4-3-6. Other Components

Positive electrode active material layer 12 may further include an inorganic filler, an organic filler, a surface modifier, a dispersant, a lubricant, a flame retardant, a protective agent, a flux, a coupling agent, an adsorbent, and/or the like, for example. Positive electrode active material layer 12 may include polyoxyethylene allylphenyl ether phosphate, zeolite, silane coupling agent, MoS₂, WO₃, and/or the like, for example.

### 4-4. Negative Electrode

Negative electrode 20 is in sheet form. Negative electrode 20 may include a negative electrode current collector 21 and a negative electrode active material layer 22, for example.

### 4-4-1. Negative Electrode Current Collector

Negative electrode current collector 21 is electrically conductive. Negative electrode current collector 21 supports negative electrode active material layer 22. Negative electrode current collector 21 may be in sheet form, for example. Negative electrode current collector 21 may have a thickness from 5 to 50 μm, for example.

Negative electrode current collector 21 may include at least one selected from the group consisting of a metal layer and an electrically-conductive resin layer. Negative electrode current collector 21 may further include a PTC layer, a buffer layer, and the like. The electrically-conductive resin layer, the PTC layer, and the buffer layer may be the same as those in positive electrode current collector 11. The metal layer may include at least one selected from the group consisting of Cu, Ni, Fe, Zn, Pb, Ag, and Au, for example. The metal layer may include a Cu foil, a Cu alloy foil, and/or the like, for example.

### 4-4-2. Negative Electrode Active Material Layer

Negative electrode active material layer 22 is placed on the surface of negative electrode current collector 21. Negative electrode active material layer 22 may be placed on only one side of negative electrode current collector 21. Negative electrode active material layer 22 may be placed on both sides of negative electrode current collector 21. Negative electrode active material layer 22 may have a thickness from 10 to 1000 μm, or from 50 to 500 μm, or from 100 to 300 μm, for example. Negative electrode active material layer 22 includes a negative electrode active material and a solid electrolyte. Negative electrode active material layer 22 may further include a conductive material, a binder, and the like, for example.

### 4-4-3. Negative Electrode Active Material

The negative electrode active material may be in powder form, or may be in sheet form, for example. The negative electrode active material may have a D50 from 1 to 30 μm, or from 10 to 20 μm, or from 1 to 10 μm, for example.

### 4-4-4. Carbon-Based Active Material

The negative electrode active material may include a carbon-based active material, for example. The carbon-based active material may include, for example, at least one selected from the group consisting of graphite, soft carbon, and hard carbon. The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The graphite may include a dopant. The dopant may include, for example, at least one selected from the group consisting of B, N, P, Li, and Ca. The amount to be added, in molar fraction, may be from 0.01 to 5%, or from 0.1 to 3%, or from 0.1 to 1%, for example.

The surface of the graphite may be covered with amorphous carbon, for example. The surface of the graphite may be covered with another type of material, for example. This another type of material may include, for example, at least one selected from the group consisting of P, W, Al, and O. The another type of material may include, for example, at least one selected from the group consisting of Al(OH)₃, AlOOH, Al₂O₃, WO₃, Li₂CO₃, LiHCO₃, and Li₃PO₄.

### 4-4-5. Alloy-Based Active Material

The negative electrode active material may include an alloy-based active material, for example. The negative electrode active material may include, for example, at least one selected from the group consisting of Si, Li silicate, SiO, Si-based alloy, Sn, SnO, and Sn-based alloy.

SiO may be represented by the following formula (3-1), for example.

SiOₓ (3-1)

In the above formula (3-1), the relationship of 0<x<2 is satisfied.

In the above formula (3-1), x may satisfy the relationship of 0.5≤x≤1.5, or 0.8≤x≤1.2, for example.

Li silicate may include, for example, at least one selected from the group consisting of Li₄SiO₄, Li₂SiO₃, Li₂Si₂O₅, and Li₈SiO₆. The negative electrode active material may include a mixture of Si and Li silicate, for example. The mixing ratio (mass ratio) may be “Si/(Li silicate)=1/9 to 9/1”, or “Si/(Li silicate)=2/8 to 8/2”, or “Si/(Li silicate)=3/7 to 7/3”, or “Si/(Li silicate)=4/6 to 6/4”, for example. The alloy-based active material (such as Si, SiO) may include an additive. The additive may be a substituted solid solution atom or an intruding solid solution atom, for example. The additive may be an adherent adhered to the surface of the alloy-based active material. The adherent may be an elementary substance, an oxide, a carbide, a nitride, a halide, and/or the like, for example. The amount to be added may be, in molar fraction, from 0.01 to 5%, or from 0.1 to 3%, or from 0.1 to 1%, for example. The additive may include, for example, at least one selected from the group consisting of Li, Na, K, Rb, Be, Mg, Ca, Sr, Fe, Ba, B, Al, Ga, In, C, Ge, Sn, Pb, N, P, As, Y, Sb, and S. That is, SiO may be doped with Mg and/or Na. For example, Mg silicate and/or Na silicate may be formed. For example, boron oxide (such as B₂O₃, for example), yttrium oxide (such as Y₂O₃, for example), and/or the like may be added to SiO.

### 4-4-6. Si—C Composite Material

The negative electrode active material may include a composite material of the carbon-based active material (such as graphite) and the alloy-based active material (such as Si), for example. A composite material including Si and carbon may also be called “a Si—C composite material”. For example, Si microparticles may be dispersed inside carbon particles. For example, Si microparticles may be dispersed inside graphite particles. For example, Li silicate particles may be covered with a carbon material (such as amorphous carbon).

### 4-4-7. Other Active Materials

The negative electrode active material may include, for example, at least one selected from the group consisting of Li metal, Li-based alloy, and Li₄Ti₅O₁₂.

### 4-4-8. Solid Electrolyte

The solid electrolyte may form an ion conduction path inside negative electrode active material layer 22. The solid electrolyte may be in particle form. The solid electrolyte may have a D50 from 0.1 to 3 μm, for example. The D50 of the solid electrolyte may be 1 μm or less, or 0.5 μm or less, for example. The amount of the solid electrolyte to be used may be, for example, from 1 to 200 parts by volume, or from 50 to 150 parts by volume, or from 50 to 100 parts by volume, relative to 100 parts by volume of the negative electrode active material. The solid electrolyte of negative electrode active material layer 22 and that of positive electrode active material layer 12 may be the same as one another, or may be different from each other. Negative electrode active material layer 22 may include, for example, at least one selected from the group consisting of a sulfide solid electrolyte, a halide solid electrolyte, an oxide solid electrolyte, a hydride solid electrolyte, and a nitride solid electrolyte.

### 4-4-9. Conductive Material

The conductive material may form an electron conduction path inside negative electrode active material layer 22. The amount of the conductive material to be used may be, for example, from 0.1 to 10 parts by mass relative to 100 parts by mass of the negative electrode active material. The conductive material of negative electrode active material layer 22 and that of positive electrode active material layer 12 may be the same as one another, or may be different from each other.

### 4-4-10. Binder

The binder is capable of fixing negative electrode active material layer 22 to negative electrode current collector 21. The amount of the binder to be used may be, for example, from 0.1 to 10 parts by mass relative to 100 parts by mass of the negative electrode active material. The binder may include any component. The binder may include, for example, at least one selected from the group consisting of styrene-butadiene rubber (SBR), acrylate butadiene rubber (ABR), sodium alginate, CMC (such as CMC-H, CMC-Na, CMC-Li, CMC-NH₄), PAA (such as PAA-H, PAA-Na, PAA-Li), polyacrylonitrile (PAN), PVdF, PTFE, acrylic resin (acrylic acid ester copolymer), methacrylic resin (methacrylic acid ester copolymer), PVP, PVA, and derivatives of these. For example, the expression “CMC-Na” refers to a Na salt of CMC. For example, the expression “CMC-H” refers to an acid-type CMC. The same applies to “PAA-Na” and the like.

### 4-4-11. Other Components

Negative electrode active material layer 22 may further include an inorganic filler, an organic filler, a surface modifier, a dispersant, a lubricant, a flame retardant, a protective agent, a flux, a coupling agent, an adsorbent, and/or the like, for example. Negative electrode active material layer 22 may include a layered silicate (such as smectite, montmorillonite, bentonite, hectorite), an inorganic filler (such as solid alumina, hollow silica, boehmite), a polysiloxane compound, and/or the like, for example.

### 4-5. Separator Layer

Separator layer 30 is interposed between positive electrode 10 and negative electrode 20. Separator layer 30 separates positive electrode 10 from negative electrode 20. Separator layer 30 may have a thickness from 1 to 50 μm, for example.

Separator layer 30 may also be called “a solid electrolyte layer”. Separator layer 30 includes a solid electrolyte. Separator layer 30 may further include a binder, for example. The solid electrolyte of separator layer 30 and that of the electrode active material layer may be the same as one another, or may be different from each other. Separator layer 30 may include, for example, at least one selected from the group consisting of a sulfide solid electrolyte, a halide solid electrolyte, an oxide solid electrolyte, a hydride solid electrolyte, and a nitride solid electrolyte. The amount of the binder to be used may be, for example, from 0.1 to 10 parts by mass relative to 100 parts by mass of the solid electrolyte. The binder of separator layer 30 and that of the electrode active material layer may be the same as one another, or may be different from each other.

Separator layer 30 may have a monolayer structure, or may have a multilayer structure. For example, separator layer 30 may have a structure of two to five layers. For example, each layer may have a different solid electrolyte. For example, each layer may have a different density. For example, each layer may have a different solid electrolyte particle size (such as D50, for example).

For example, separator layer 30 may include a first layer 31 and a second layer 32. First layer 31 is in contact with positive electrode active material layer 12. Second layer 32 is in contact with negative electrode active material layer 22. The ratio of the thickness between first layer 31 and second layer 32 may be “(first layer)/(second layer)=1/9 to 9/1”, or “(first layer)/(second layer)=3/7 to 7/3”, for example.

The composition of first layer 31 may be different from that of second layer 32. For example, it is possible that first layer 31 includes a sulfide solid electrolyte and second layer 32 includes a halide solid electrolyte. For example, it is possible that first layer 31 includes a halide solid electrolyte and second layer 32 includes a sulfide solid electrolyte. It is possible that first layer 31 includes both a sulfide solid electrolyte and a halide solid electrolyte. It is possible that second layer 32 includes both a sulfide solid electrolyte and a halide solid electrolyte. The volume ratio of the halide solid electrolyte to the sulfide solid electrolyte in first layer 31 (a first volume ratio) may be higher than the volume ratio of the halide solid electrolyte to the sulfide solid electrolyte in second layer 32 (a second volume ratio). The first volume ratio may be lower than the second volume ratio.

### EXAMPLES

### 5. Production of Positive Electrode Active Material

### 5-1. Synthesis of O2-Type Layered Oxide

### 5-1-1. Coprecipitation Synthesis, Precursor Preparation

MnSO₄·5H₂O, NiSO₄·6H₂O, and CoSO₄·7H₂O were weighed so that a molar ratio of “Mn/Ni/Co=5/2/3” was achieved. These materials were dissolved in distilled water to form a first aqueous solution. The concentration of the first aqueous solution was 1.2 mol/L.

Na₂CO₃ was dissolved in distilled water to form a second aqueous solution. The concentration of the second aqueous solution was 1.2 mol/L.

A reaction vessel equipped with a baffle plate was prepared. Into the reaction vessel, 1000 mL of deionized water was added. At a rate of about 4 mL/min, the first aqueous solution (500 mL) and the second aqueous solution (500 mL) were added dropwise to the reaction solution.

After the dropwise addition, the material in the reaction vessel was stirred at room temperature at a rate of 150 rpm. After one hour of stirring, the product inside the reaction vessel was collected. The product was dispersed in deionized water to form a dispersion. In other words, the product was rinsed with deionized water. With the use of a centrifuge, the dispersion was subjected to solid-liquid separation. The separated sediment was collected.

The sediment was dried at 120° C. for 8 hours. After drying, the sediment was pulverized in a mortar. The pulverized product was further subjected to air classification treatment to obtain coarse particles (a precursor).

### 5-1-2. Na Calcination

Na₂CO₃ was added to distilled water. The resulting aqueous solution was stirred with a stirrer until Na₂CO₃ was completely dissolved. Thus, a third aqueous solution was formed. The concentration of the third aqueous solution was 1150 g/L.

The precursor was mixed with the third aqueous solution so that a composition of Na_{0.7}Mn_{0.5}Ni_{0.2}Co_{0.3}O₂ was achieved, to form a slurry.

The resulting slurry was dried with the use of a spray drying apparatus “DL410” (a product manufactured by Yamato Scientific), and, thereby, the precursor was coated with Na₂CO₃. The drying conditions were as described below.
Slurry feeding rate: 30 mL/min
Inlet temperature: 200° C.
Air circulation amount: 0.8 m³/min
Spraying air pressure: 0.3 MPa

The precursor was placed in an alumina crucible. The precursor was subjected to heat treatment in an air atmosphere in an electric furnace to obtain a calcined product. The resulting calcined product was collected from the electric furnace at 250° C. The calcined product was pulverized in a dry atmosphere. Thus, a P2-type layered oxide including Na was obtained.

### 5-1-3. Na/Li Ion Exchange

LiNO₃ was mixed with LiCl to form a Li raw material. The mixing ratio was “LiNO₃/LiCl=1/1 (molar ratio)”. The Li raw material was mixed with the P2-type layered oxide to form a mixture. The amount of the Li raw material thus mixed was 10 times the amount necessary for replacing the entire amount of Na of the P2-type layered oxide with Li.

The mixture was placed in the alumina crucible. The mixture was subjected to heat treatment in an air atmosphere. The temperature of the heat treatment was 280° C. The duration of the heat treatment was 1 hour. In this manner, Na of the P2-type layered oxide was replaced with Li. After the heat treatment, the layered compound was dispersed in deionized water to form a dispersion. In other words, the layered compound was rinsed with deionized water. The dispersion was subjected to solid-liquid separation by vacuum filtration. The sediment was dried at 120° C. for 8 hours. In this manner, an O2-type layered oxide was synthesized.

### 5-2. Coating

### No. 1

Into a vessel, 870.4 parts by mass of hydrogen peroxide solution (mass concentration, 30%) was added. Then, 987.4 parts by mass of ion-exchanged water and 44.2 parts by mass of niobic acid [Nb₂O₅·3H₂O] were added to the vessel. Then, 87.9 parts by mass of aqueous ammonia solution (mass concentration, 28%) was added to the vessel. The content of the vessel was sufficiently stirred to form a coating liquid. It is conceivable that the resulting coating liquid included a peroxo complex of Nb.

Active material particles were dispersed in the coating liquid to prepare a slurry. The solid concentration of the slurry was 42%. The active material particles were the O2-type layered oxide obtained in the above-described manner. A spray drying apparatus with the trade name “Mini Spray Dryer B-290” manufactured by BUCHI was prepared. The slurry was dried with the use of the spray drying apparatus to produce a positive electrode active material. The temperature of air supplied by the spray drying apparatus was 200° C., and the amount of air supply was 0.45 m³/min. The positive electrode active material was subjected to heat treatment in an air atmosphere. The temperature of the heat treatment was 200° C. The duration of the heat treatment was 5 hours. It is conceivable that the coating film of No. 1 includes Nb.

### No. 2

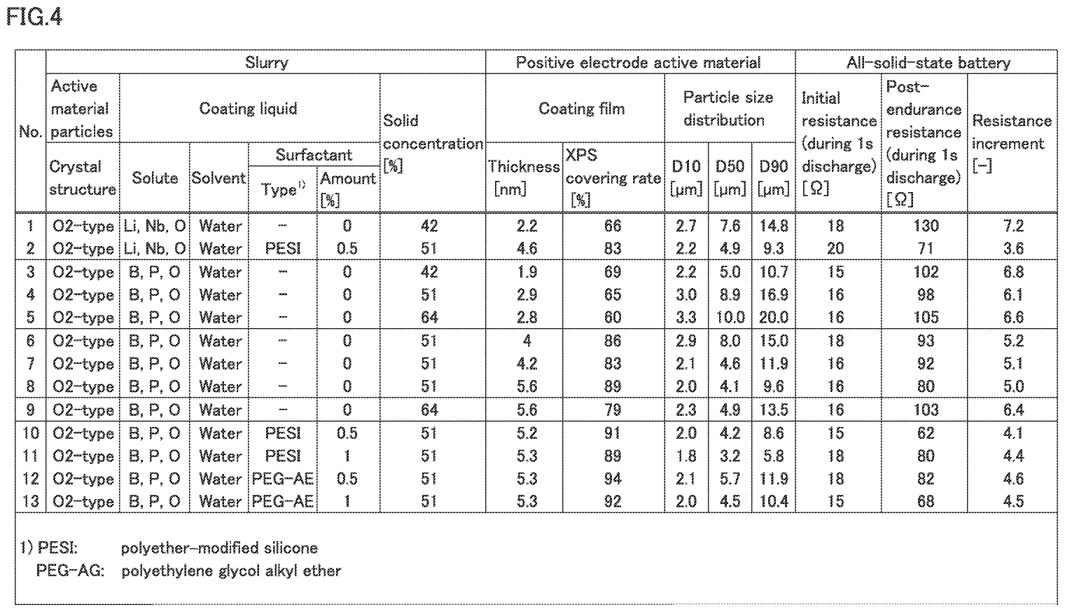

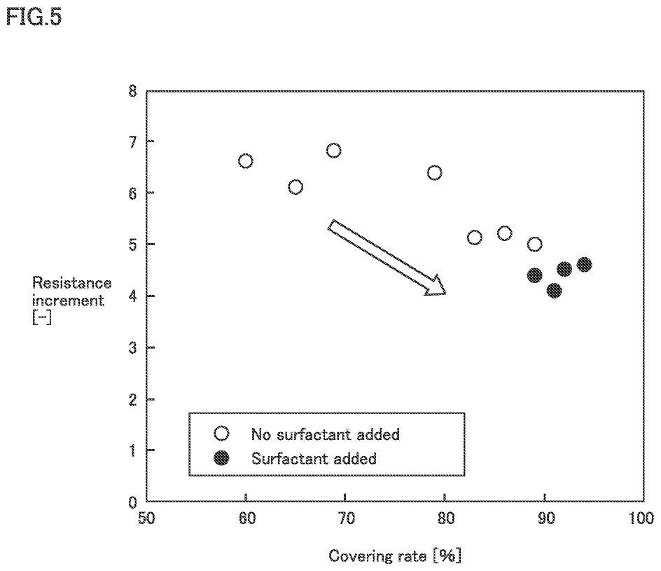

FIG. 4 is a table showing details of experiment. No. 2 is different from No. 1 in the concentration of the coating liquid and the solid concentration of the slurry. Further, in No. 2, a surfactant was added to the coating liquid. Except for these, in the same manner as in No. 1, a positive electrode active material was produced.

### No. 3

In 166 parts by mass of ion-exchanged water, 10.8 parts by mass of metaphosphoric acid (manufactured by FUJIFILM Wako Pure Chemical) was dissolved to form an aqueous solution. To the resulting aqueous solution, boric acid (manufactured by Nacalai Tesque) was further dissolved so that “P/B=1/1 (molar ratio)” was achieved, and thereby a coating liquid was prepared. Active material particles were dispersed in the resulting coating liquid to prepare a slurry. The solid concentration of the slurry was 42%. Except for these, in the same manner as in No. 1, a positive electrode active material was produced.

### Nos. 4, 5

A positive electrode active material was produced in the same manner as in No.

3 except that the solid concentration of the slurry was changed.

### Nos. 6 to 8

A positive electrode active material was produced in the same manner as in No. 4 except that the concentration of the coating liquid was changed.

### No. 9

A positive electrode active material was produced in the same manner as in No. 5 except that the concentration of the coating liquid was changed.

### No. 10

A positive electrode active material was produced in the same manner as in No.

8 except that a surfactant was added to the coating liquid.

### No. 11

A positive electrode active material was produced in the same manner as in No. 10 except that the amount of the surfactant to be added was changed.

### No. 12

A positive electrode active material was produced in the same manner as in No.

10 except that the type of the surfactant was changed.

### No. 13

A positive electrode active material was produced in the same manner as in No. 11 except that the type of the surfactant was changed.

### 6. Evaluation

### 6-1. Production of Test Battery

The positive electrode active material, a sulfide solid electrolyte, a conductive material, a binder, and a dispersion medium were mixed together to prepare a positive electrode slurry. The mixing ratio between the positive electrode active material and the sulfide solid electrolyte was “(positive electrode active material)/(sulfide solid electrolyte)=6/4 (volume ratio)”. The ratio of the other components was “(positive electrode active material)/(conductive material)/binder=100/3/3 (mass ratio)”. The positive electrode slurry was sufficiently stirred with the use of an ultrasonic homogenizer. The positive electrode slurry was applied to the surface of a positive electrode current collector to form a coating film. The coating film was dried on a hot plate at 100° C. for 30 minutes. In this manner, a positive electrode raw sheet was produced. From the resulting positive electrode raw sheet, a disk-shaped positive electrode was cut out. The area of the positive electrode was 1 cm².

A negative electrode and a separator layer were prepared. The negative electrode active material was graphite. The same type of sulfide solid electrolyte was used for the positive electrode, the separator layer, and the negative electrode. Inside a tubular jig, the positive electrode, the separator layer, and the negative electrode were stacked in this order to form a stack. The resulting stack was pressed to form a power generation element. A terminal was connected to the power generation element to produce a test battery (an all-solid-state battery).

### 6-2. Measurement of Resistance Increment

Inside a thermostatic chamber (the temperature set at 25° C.), OCV (Open Circuit Voltage) of the test battery was adjusted to 3.85 V. After the OCV adjustment, the test battery was discharged at a current of 3 C for 0.1 seconds and initial resistance was measured. “C” is a symbol denoting the hour rate of current. With a current of 1 C, the rated capacity of a battery is discharged in 1 hour.

Inside a thermostatic chamber (the temperature set at 60° C.), the test battery was stored for 4 weeks. During storage, OCV of the test battery was controlled at 4.80 V.

After 4 weeks of storage, inside a thermostatic chamber (the temperature set at 25° C.), post-endurance resistance was measured in the same manner as for the initial resistance. The post-endurance resistance was divided by the initial resistance to determine the resistance increment.

### 7. Results

Referring to FIG. 4, when the solid concentration of the slurry is more than 42% and not more than 51%, resistance increment tends to be small.

When the thickness of the coating film is 4 nm or more and the covering rate is 80% or more, resistance increment tends to be small.

FIG. 5 is a graph of the relationship between covering rate and resistance increment. In the graph of FIG. 5, results of Nos. 3 to 13 are plotted. When the coating liquid includes a surfactant, the covering rate tends to be high. When the covering rate is 80% or more, resistance increment is good.

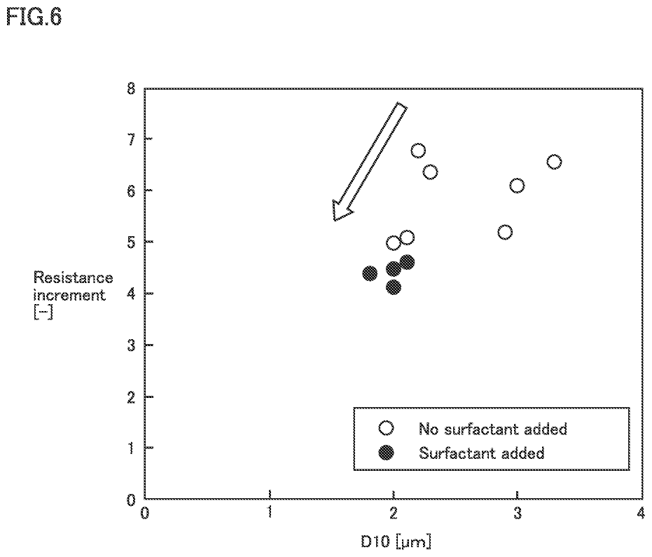

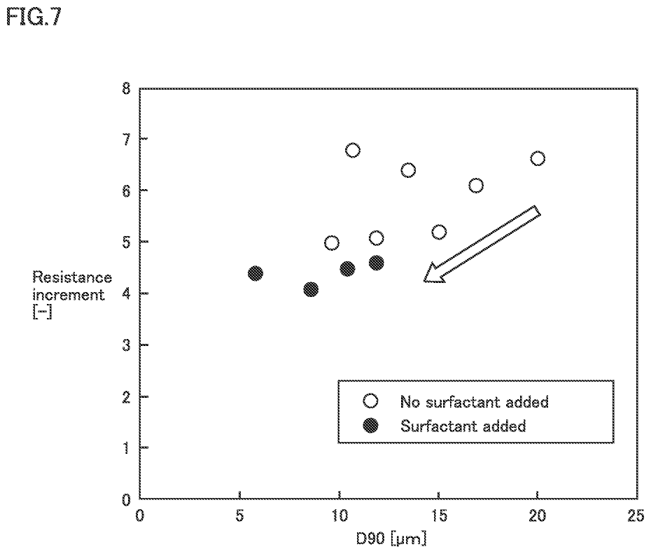

FIG. 6 is a graph of the relationship between D10 and resistance increment. In the graph of FIG. 6, results of Nos. 3 to 13 are plotted. When the coating liquid includes a surfactant, D10 tends to be small. The smaller the D10 is, the smaller the resistance increment tends to be.

FIG. 7 is a graph of the relationship between D90 and resistance increment. In the graph of FIG. 7, results of Nos. 3 to 13 are plotted. When the coating liquid includes a surfactant, D90 tends to be small. The smaller the D90 is, the smaller the resistance increment tends to be.

What is claimed is:

1. A method of producing a positive electrode active material, comprising:
(a) preparing a slurry by dispersing an active material particle in a coating liquid; and
(b) performing spray drying to dry the slurry to produce a positive electrode active material, wherein
the active material particle includes an O2-type layered oxide,
the coating liquid includes a solute and a solvent,
the solute includes at least one selected from the group consisting of Nb, P, and B, and
the slurry has a solid concentration of more than 42% and not more than 51%.

2. The method of producing a positive electrode active material according to claim 1, wherein
the coating liquid further includes a surfactant, and
the surfactant includes at least one selected from the group consisting of polyether-modified silicone and polyethylene glycol alkyl ether.

3. A positive electrode active material comprising:
an active material particle; and
a coating film, wherein
the active material particle includes an O2-type layered oxide,
the coating film covers at least part of a surface of the active material particle,
the coating film includes at least one selected from the group consisting of Nb, P, and B,
the coating film has a thickness of 4 nm or more,
a covering rate which is a rate at which the surface of the active material particle is covered with the coating film is 80% or more, and
the covering rate is measured by X-ray photoelectron spectrometry.

4. The positive electrode active material according to claim 3, wherein the positive electrode active material has a D10 of 3 μm or less in volume-based particle size distribution.

5. The positive electrode active material according to claim 3, wherein the positive electrode active material has a D90 of 15 μm or less in volume-based particle size distribution.

6. An all-solid-state battery comprising the positive electrode active material according to claim 3 and a sulfide solid electrolyte.
